(19) United States
(12) Patent Application Publication
(10) Pub. No.: US 2017/0133133 A1
(43) Pub. Date: May 11, 2017

(54) MANUFACTURING METHOD OF SHUNT RESISTOR AND MANUFACTURING METHOD OF SHUNT RESISTOR ASSEMBLY

(71) Applicant: SMART ELECTRONICS INC., Ulsan (KR)

(72) Inventors: Doo Won KANG, Anyang-si, Gyeonggi-do (KR); Hyun Chang KIM, Ulsan (KR); Kyung Mi LEE, Ulsan (KR); Hwang Je MUN, Busan (KR); A Lam SHIN, Yangsan-si, Gyeongsangnam-do (KR); Tae Hun KANG, Yangsan-si, Gyeongsangnam-do (KR)

(21) Appl. No.: 15/039,357

(22) PCT Filed: Dec. 12, 2013
(86) PCT No.: PCT/KR13/11657

§ 371 Date: May 25, 2016

(30) Foreign Application Priority Data
Nov. 26, 2013 (KR) 10-2013-0144530

(51) Int. Cl. H01C 17/28; B29C 65/70; B29C 65/16

(52) U.S. Cl. CPC H01C 17/28; B29C 65/16; B29C 65/70; B29L 2031/3487

(57) ABSTRACT

Disclosed are a manufacturing method of a shunt resistor and a manufacturing method, in which a resistor element and connection pieces may be bonded through laser or electron beam welding so as to prevent welding distortion as much as possible, and measurement terminals may be manufactured by a simple pressing and bending process.

### TECHNICAL FIELD

The present invention relates to a manufacturing method of a shunt resistor and a manufacturing method of a shunt resistor assembly, and more particularly to a manufacturing method of a shunt resistor and a manufacturing method of a shunt resistor assembly in which a resistor element and connection pieces are bonded through laser or electron beam welding so as to prevent welding distortion as much as possible, and measurement terminals are manufactured by a simple pressing and bending process.

### BACKGROUND ART

In general, a shunt resistor used to detect current is used as a divided resistor when DC high current is measured, and may use low resistance less than 1Ω so as to prevent voltage drop and power loss.

Shunt resistors include a non-inductive wire wound resistor (PRN), a super-mini wire wound resistor (SMW), a non-inductive metal plate resistor (MPR), a current sensing resistor (CSR), and a high current sensing resistor (CSR).

Among these shunt resistors, the high CSR serves to precisely measure voltage, current, and temperature of a vehicle battery, to predict charging state, aging state, and startability of the battery, and to transmit state information of the battery to an electronic control unit (ECU) to normally operate various devices connected to the battery.

Korean Patent Laid-open Publication No. 10-2012-0047925 discloses a low resistive current sensitive resistor 1.

FIG. 11 is a cross-sectional view illustrating a conventional shunt resistor. With reference to FIG. 11, the low resistive current sensitive resistor includes at least one plate-shaped connection part 2 and 3 and at least one contact point 7 and 8 for contact of the at least one plate-shaped connection part 2 and 3, and the at least one contact point 7 and 8 is formed by embossed regions of the at least one plate-shaped connection part 2 and 3. Here, two contact points 7 and 8 serve to measure voltage dropped throughout a resistor element.

However, in the above Korean Patent, since the embossing region includes a through hole, the contact points should be separated from the resistor element and thus, a voltage measurement error is generated as much as the separation distance.

Further, since the above Korean Patent does not disclose a bonding method of the plate-shaped connection parts 2 and 3 and the resistor in detail, a bonding method satisfying characteristics of the shunt resistor is required.

### DISCLOSURE

### Technical Problem

Therefore, the present invention has been made in view of the above problems, and it is an object of the present invention to provide a manufacturing method of a shunt resistor and a manufacturing method of a shunt resistor assembly in which a resistor element and connection pieces are bonded through laser or electron beam welding so as to prevent welding distortion as much as possible.

It is another object of the present invention to provide a manufacturing method of a shunt resistor and a manufacturing method of a shunt resistor assembly in which measurement terminals are manufactured by a simple pressing and bending process.

### Technical Solution

In accordance with an aspect of the present invention, the above and other objects can be accomplished by the provision of a manufacturing method of a shunt resistor including preparing a resistor element and first and second connection pieces and bonding the first and second connection pieces to both ends of the resistor element, pressing measurement terminals, each of which includes a base part and a measurement protrusion, and then bending the measurement protrusions upwardly from the base parts, and bonding the base parts to the upper surfaces of the first and second connection pieces.

The bonding of the first and second connection pieces to both ends of the resistor element may be carried out by welding the resistor element and the first and second connection pieces using a laser.

The bonding of the first and second connection pieces to both ends of the resistor element may be carried out through laser welding under the condition that the upper surfaces of the first and second connection pieces are pressed by pressing members.

The bonding of the first and second connection pieces to both ends of the resistor element may include heating the rear surfaces of the bonded resistor element and first and second connection pieces, after bonding of the first and second connection pieces to both ends of the resistor element.

The bonding of the first and second connection pieces to both ends of the resistor element may be carried out by welding the resistor element and the first and second connection pieces using an electron beam (E-beam).

The bonding of the first and second connection pieces to both ends of the resistor element may be carried out using the E-beam of 100,000˜150,000 Volt in a vacuum atmosphere of at least 10⁻⁵ torr.

A receiving groove may be formed on one surface of each the first and second connection pieces in the bonding of the first and second connection pieces to both ends of the resistor, and the bonding of the base parts to the upper surfaces of the first and second connection pieces may be carried out by applying a conductive bonding member, such as a solder cream, to the receiving grooves.

In accordance with another aspect of the present invention, there is provided a manufacturing method of shunt resistor assembly including preparing a resistor element and first and second connection pieces and bonding the first and second connection pieces to both ends of the resistor element, pressing measurement terminals, each of which includes a base part and a measurement protrusion, and then bending the measurement protrusions upwardly from the base parts, bonding the base parts to the upper surfaces of the first and second connection pieces so as to manufacture a shunt resistor, forming a casing by performing insert injection molding of the shunt resistor, and combining a substrate, on which a measurement unit is mounted, with the casing.

In the formation of the casing, insert injection molding may be carried out so that the measurement protrusions are exposed to the outside of the casing and, in the combination of the substrate, on which a measurement unit is mounted, with the casing, connection between the measurement protrusions and the measurement unit may be carried out under the condition that the measurement protrusions are inserted into the measurement unit.

### Advantageous Effects

As described above, a manufacturing method of a shunt resistor and a manufacturing method of a shunt resistor assembly in accordance with the present invention may bond a resistor element and connection pieces through laser or electron beam welding and thus, prevent welding distortion as much as possible.

Further, the manufacturing method of a shunt resistor and the manufacturing method of a shunt resistor assembly in accordance with the present invention may manufacture measurement terminals by a simple pressing and bending process.

### DESCRIPTION OF DRAWINGS

The above and other objects, features and other advantages of the present invention will be more clearly understood from the following detailed description taken in conjunction with the accompanying drawings, in which:

FIG. 1 is a flowchart illustrating a manufacturing method of a shunt resistor in accordance with the present invention;

FIG. 2 is a perspective view illustrating first and second connection pieces and a resistor element in accordance with the present invention;

FIG. 3 is a conceptual view illustrating laser welding between the first and second connection pieces and the resistor element in accordance with the present invention;

FIG. 4A is a cross-sectional view illustrating use of pressing members during laser welding in accordance with the present invention;

FIG. 4B is a cross-sectional view illustrating heating of the rear surfaces of the bonded resistor element and first and second connection pieces;

FIG. 4C is a perspective view illustrating the bonded resistor element and first and second connection pieces in accordance with the present invention;

FIG. 5A is a cross-sectional view illustrating welding between the first and second connection pieces and the resistor element in accordance with the present invention in a vacuum chamber by an E-beam;

FIG. 5B is a cross-sectional view illustrating continuous execution of E-beam bonding using three vacuum chambers;

FIG. 6A is a development view illustrating a pressed state of a measurement terminal in accordance with the present invention;

FIG. 6B is a perspective view illustrating bending of the measurement terminal in accordance with the present invention;

FIG. 7A is a perspective view illustrating the shunt resistor in accordance with the present invention;

FIG. 7B is a cross-sectional view illustrating combination of measurement terminals with the connection pieces in accordance with the present invention;

FIG. 8 is a flowchart illustrating a manufacturing method of a shunt resistor assembly in accordance with one embodiment of the present invention;

FIG. 9 is a cross-sectional view illustrating formation of a casing by performing insert injection molding of the shunt resistor in accordance with the present invention;

FIG. 10 is a cross-sectional view illustrating mounting of a measurement unit on the casing in accordance with the present invention; and

FIG. 11 is a cross-sectional view illustrating a conventional shunt resistor.

### BEST MODE

Hereinafter, preferred embodiments of the present invention will be described in detail with reference to the annexed drawings.

In the following description of the present invention, a detailed description of known functions and configurations incorporated herein will be omitted when it may make the subject matter of the present invention rather unclear. In addition, the terms used in the following description are terms defined taking into consideration the functions obtained in accordance with the present invention. The definitions of these terms should be determined based on the whole content of this specification because they may be changed in accordance with the intention of a user or operator or a usual practice.

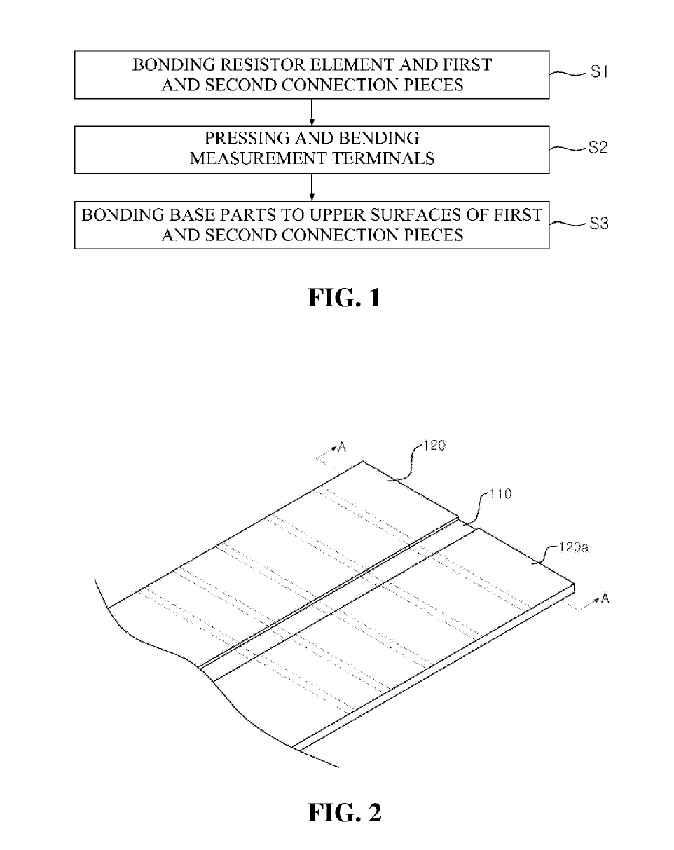

FIG. 1 is a flowchart illustrating a manufacturing method of a shunt resistor in accordance with the present invention.

With reference to FIG. 1, a manufacturing method of a shunt resistor in accordance with the present invention may include bonding a resistor element and first and second connection pieces (Operation S1), pressing and bending measurement terminals (Operation S2), and bonding the measurement terminals to the first and second connection pieces (Operation S3).

FIG. 2 is a perspective view illustrating the first and second connection pieces and the resistor element in accordance with the present invention.

With reference to FIG. 2, in Operation S1, a first connection piece 120 into which current to be measured is introduced, a second connection piece 120a from which the current to be measured is discharged, and a resistor element 110 disposed between the first and second connection pieces 120 and 120a are prepared, and the first and second connection pieces 120 and 120a are bonded to both ends of het resistor element 110.

The first and second connection pieces 120 and 120a are formed of a conductive material, for example, copper.

The resistor element 110 is disposed between the first and second connection pieces 120 and 120a and causes voltage drop. For example, the resistor element 110 may be formed of a low resistance material having greater specific resistance than the first and second connection pieces 120 and 120a, particularly, an alloy including Cu, Mn, or Ni.

The resistor element 110 and the first and second connection pieces 120 and 120a may be bonded through laser welding or electron beam welding.

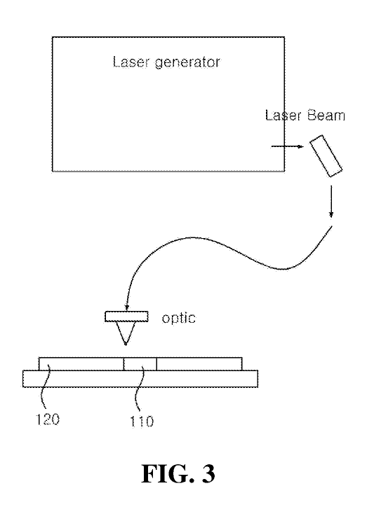

FIG. 3 is a conceptual view illustrating laser welding between the first and second connection pieces and the resistor element in accordance with the present invention.

With reference to FIG. 3, in Operation S1 of the present invention, the first and second connection pieces 120 and 120a and the resistor element 110 may be bonded through laser welding.

Such laser welding is performed between the first and second connection pieces 120 and 120a and the resistor element 110 using a welding optic head under the condition that the first and second connection pieces 120 and 120a and the resistor element 110 are placed on a zig.

For example, laser welding may be performed using a laser of a wavelength of 1,030˜1,070 mm.

For example, a laser output from a laser generator is reflected by a reflective shutter, and is emitted via an optical cable and the welding optic head, thus performing laser welding.

Such laser welding will be compared to electron beam welding, which will be described later, as follows.

(1) A laser welding apparatus may be installed at a low cost corresponding to ⅙ of that of an electron beam welding apparatus.

(2) Laser welding is performed at atmospheric pressure. On the other hand, electron beam welding is driven under the condition that a vacuum state is maintained and thus, requires a high cost.

(3) However, laser welding may cause distortion of a region where welding is performed, as compared to electron beam welding.

Therefore, in the present invention, pressing members may be used so as to eliminate such distortion during laser welding.

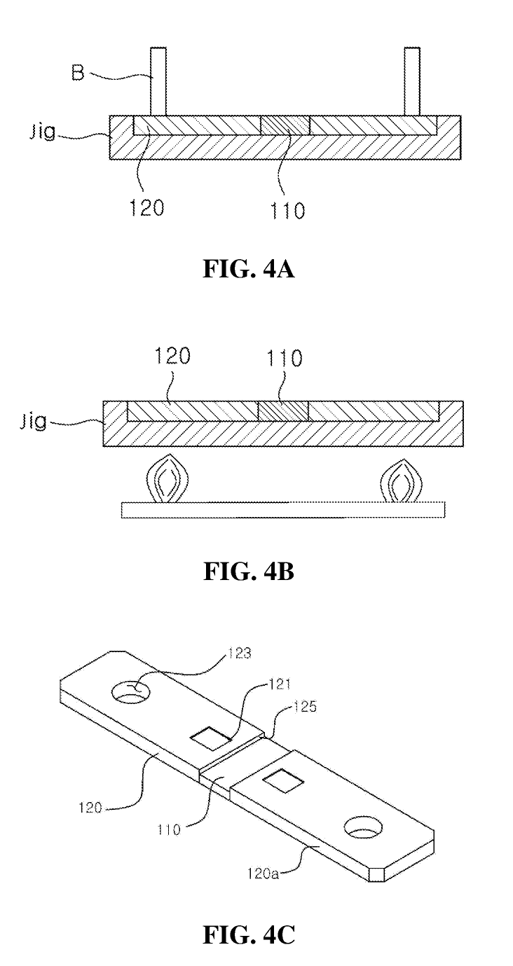

FIG. 4A is a cross-sectional view illustrating use of the pressing members during laser welding in accordance with the present invention, FIG. 4B is a cross-sectional view illustrating heating of the rear surfaces of the bonded resistor element and first and second connection pieces, and FIG. 4C is a perspective view illustrating the bonded resistor element and first and second connection pieces in accordance with the present invention.

With reference to FIG. 4A, in the present invention, in order to prevent distortion caused by laser welding as much as possible, laser welding is performed under the condition that the first and second connection pieces 120 and 120a are pressed by pressing members B and thus, distortion of a welding region by stress may be prevented.

With reference to FIG. 4B, Operation S1 of the present invention may include heating the rear surfaces of the bonded resistor elements 110 and first and second connection pieces 120 and 120a (Operation S10), after bonding of the first and second connection pieces 120 and 120a to both ends of the resistor element 110.

In Operation S10, heat treatment may be performed at a temperature of 250˜300° C., which is around 25% based on the melding point of copper (melding point: 1,084° C.) or an alloy including copper

With reference to FIG. 4C, when welding between the resistor element 110 and the first and second connection pieces 120 and 120a has been completed, the resistor element 110 and the first and second connection pieces 120 and 120a are cut according to product specifications, through holes 123 and receiving grooves are formed on the first and second connection pieces 120 and 120a, and the resistor element 110 and the first and second connection pieces 120 and 120a are washed through tumbling.

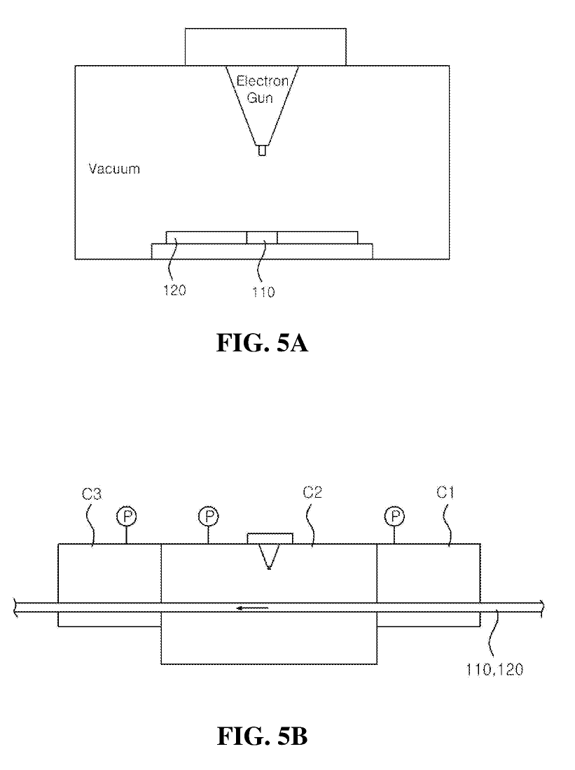

FIG. 5A is a cross-sectional view illustrating welding between the first and second connection pieces and the resistor element in accordance with the present invention in a vacuum chamber by an E-beam, and FIG. 5B is a cross-sectional view illustrating continuous execution of E-beam bonding using three vacuum chambers.

With reference to FIG. 5A, in Operation S1 of the present invention, electron beam welding is performed in a vacuum chamber, such a vacuum chamber is kept in a vacuum atmosphere of at least 10⁻⁵ torr, and an emitted electron beam has energy of 100,000˜150,000 Volt.

Electron beam welding is performed in a vacuum state and may prevent oxidation of a welding region, and temporarily applies high-density energy (100 km/m²) and may little cause welding distortion.

With reference to FIG. 5B, electron beam welding may be performed using an electron beam welding apparatus configured such that first and second sub-chambers C1 and C3 are disposed at both sides of a main chamber C2.

A vacuum suction device is installed in all of the main chamber C2 and the first and second sub-chambers C1 and C3, and the main chamber C2 and the first and second sub-chambers C1 and C3 are communicated with each other.

The resistor element 110 and the first and second connection pieces 120 and 120a are continuously supplied into the electron beam welding apparatus through the first sub-chamber C1, electron beam welding is performed in the main chamber C2, and then, the resistor element 110 and the first and second connection pieces 120 and 120a is discharged to the outside through the second sub-chamber C3.

The resistor element 110 and the first and second connection pieces 120 and 120a wound in a roll shape are supplied into such a vacuum apparatus, and then, welding between the resistor element 110 and the first and second connection pieces 120 and 120a is performed.

The first and second sub-chambers C1 and C3 serve to maintain the vacuum state of the inside of the main chamber even if a material which is a target to be welded is continuously supplied from the outside.

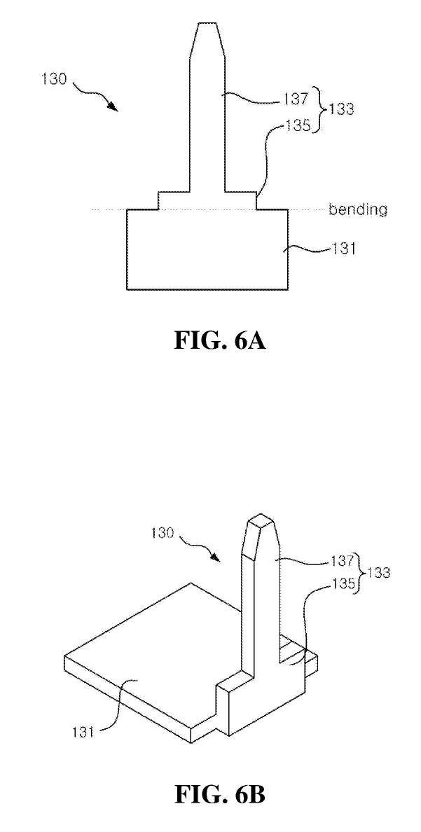

FIG. 6A is a perspective view illustrating a pressed state of the measurement terminal in accordance with the present invention, and FIG. 6B is a perspective view illustrating bending of the measurement terminal in accordance with the present invention.

With reference to FIGS. 6A and 6B, in Operation S2 in accordance with the present invention, measurement terminals, each of which includes a base part and a measurement protrusion, are pressed and then, the measurement protrusion is bent upwardly from the base part.

First and second measurement terminals 130 and 130a serve to measure voltage dropped throughout the resistor element 110, and are combined with the first and second connection pieces 120 and 120a.

The first and second measurement terminals 130 and 130a may be disposed close to the resistor element 110 so as to reduce a measurement error of voltage.

For example, each of the first and second measurement terminals 130 and 130a may include a base part 131 bonded to one surface of each of the first and second connection pieces 120 and 120a, and a measurement protrusion 133 formed integrally with the base part 131 and bent upwardly from the base part 131.

The base part 131 is formed in a plate shape broader than the measurement protrusion 133, and thus enhancement in mechanical combining force may be expected. The base part 131 may be combined with each of the first and second measurement terminals 130 and 130a through soldering.

The measurement protrusion 133 is connected to a circuit unit, which will be described later, and detects voltage of a corresponding region.

The measurement protrusion 133 may include a support part 135 extending from the base part 131 and having a narrower width than that of the base part 131, and a connection terminal part 137 extending from the support part 135 and having a narrower width than that of the support part 135.

The measurement protrusion 133 is bent at a region close to the resistor element 110.

The support part 135 has a wider width than that of the connection terminal part 137, and may thus serve to prevent breakage of a bending region during bending of the measurement protrusion 133 and to support a substrate, which will be described later.

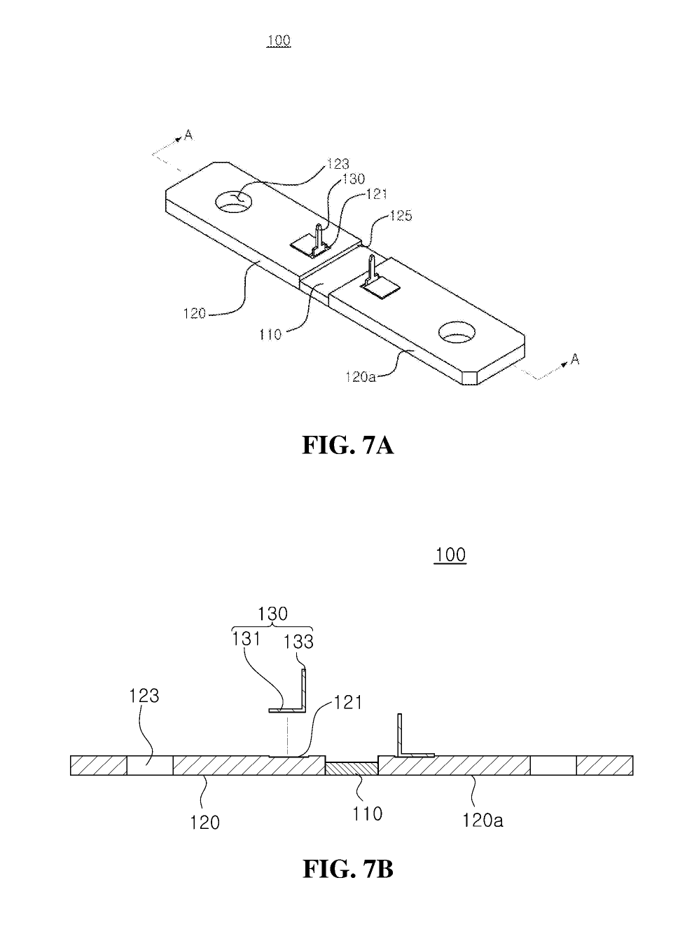

FIG. 7A is a perspective view illustrating the shunt resistor in accordance with the present invention, and FIG. 7B is a cross-sectional view illustrating combination of the measurement terminals with the connection pieces in accordance with the present invention.

With reference to FIGS. 7A and 7B, in Operation S3 in accordance with the present invention, the base parts of the bent measurement terminals are bonded to the upper surfaces of the first and second connection pieces.

Receiving grooves 121 may be formed on the upper surfaces of the first and second connection pieces 120 and 120a so as to receive the base parts 131 of the first and second measurement terminals 130 and 130a.

If the first and second measurement terminals 130 and 130a are soldered within the receiving grooves 121, not only the lower surfaces of the base parts 131 but also the side surfaces of the receiving grooves 121 and the side surfaces of the base parts 131 are soldered and thus, combining force may be improved.

Further, the receiving grooves 121 guide the combining positions of the first and second measurement terminals 130 and 130a with the first and second connection pieces 120 and 120a, thus lowering a defect rate.

When the first and second measurement terminals are bonded to the first and second connection pieces in such a manner, manufacture of the shunt resistor is completed.

Hereinafter, a manufacturing method of a shunt resistor assembly in accordance with the present invention will be described in detail with reference to the accompanying drawings.

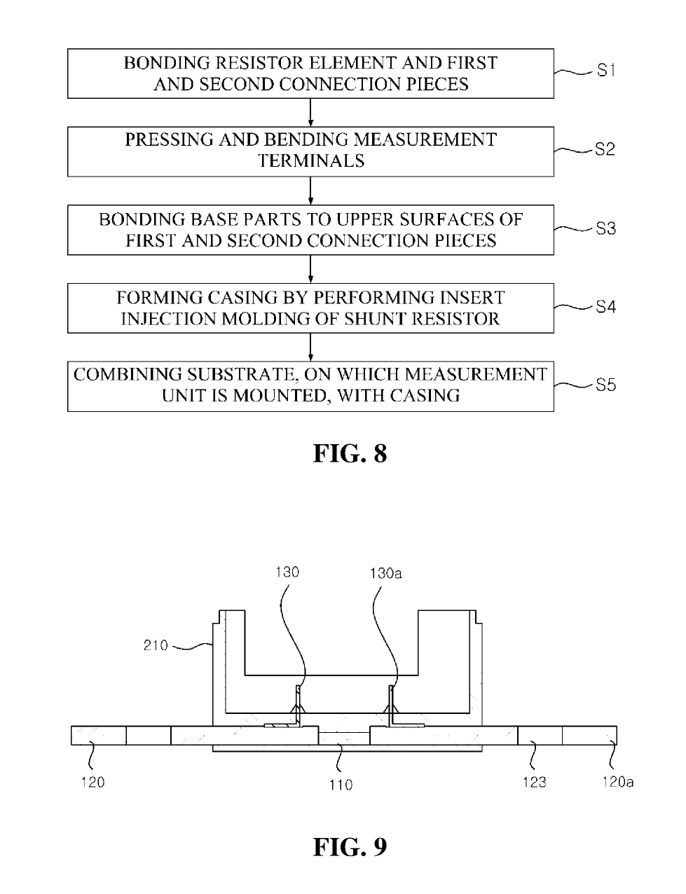

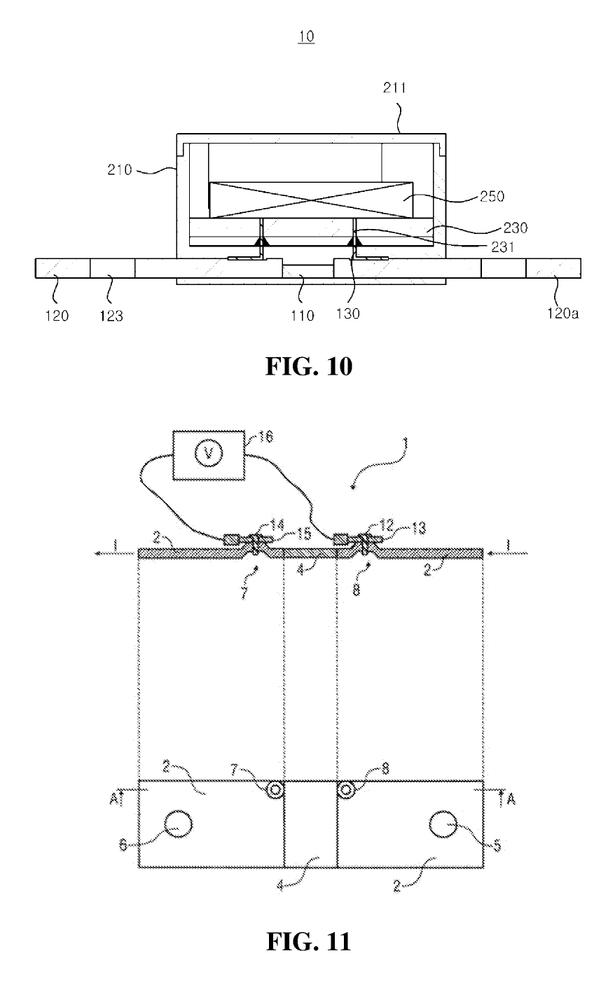

FIG. 8 is a flowchart illustrating a manufacturing method of a shunt resistor assembly in accordance with one embodiment of the present invention, FIG. 9 is a cross-sectional view illustrating formation of a casing by performing insert injection molding of the shunt resistor in accordance with the present invention, and FIG. 10 is a cross-sectional view illustrating mounting of a measurement unit on the casing in accordance with the present invention.

With reference to FIGS. 1 to 9, a manufacturing method of a shunt resistor assembly in accordance with the present invention may include preparing a resistor element 110 and first and second connection pieces 120 and 120a and bonding the first and second connection pieces 120 and 120a to both ends of the resistor element 110 (Operation S1), pressing measurement terminals 130 and 130a, each of which includes a base part 131 and a measurement protrusion 133, and then bending the measurement protrusions 133 upwardly from the base parts 131 (Operation S2), bonding the base parts 131 to the upper surfaces of the first and second connection pieces 120 and 120a so as to manufacture a shunt resistor (Operation S3), forming a casing by performing insert injection molding of the shunt resistor (Operation S4), and combining a substrate 230 with the casing 210 (Operation S5).

Here, Operation S1 to Operation S3 have been described above and a detailed description thereof will thus be omitted.

In Operation S4 in accordance with the present invention, the casing 210 is combined with the shunt resistor 100 through insert injection molding and thus, the entirety of the resistor element 110 and parts of the first and second connection pieces 120 and 120a are buried by the casing 210. In more detail, through insert injection molding, connection terminal parts 137 of the measurement protrusions 133 are exposed to the inner space of the casing 210 and support parts 135 are buried by the casing 210.

The casing 210 may be formed of an insulating material, for example, plastic, and have a box shape provided with an inner space, and a lid 211 to open and close the casing 210 may be formed.

In Operation S5 in accordance with the present invention, the connection terminal parts 137 are inserted into coupling holes 231 formed through the substrate 230 and then, the connection terminal parts 137 and the substrate 230 are connected by soldering.

A measurement unit 250 may be mounted on the substrate 230.

The measurement unit 250 serves to measure voltage values V_{R} and V_{R′} through the measurement protrusions and to convert the measured voltage values V_{R} and V_{R′} into a current value i.

### MODE FOR INVENTION

Various embodiments have been described in the best mode for carrying out the invention.

### INDUSTRIAL APPLICABILITY

As apparent from the above description, in a manufacturing method of a shunt resistor and a manufacturing method in accordance with the present invention, a resistor element and connection pieces may be bonded through laser or electron beam welding so as to prevent welding distortion as much as possible, and measurement terminals may be manufactured by a simple pressing and bending process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A manufacturing method of a shunt resistor comprising:
preparing a resistor element and first and second connection pieces, and bonding the first and second connection pieces to both ends of the resistor element;
pressing measurement terminals, each of which includes a base part and a measurement protrusion, and then bending the measurement protrusions upwardly from the base parts; and
bonding the base parts to the upper surfaces of the first and second connection pieces.

2. The manufacturing method according to claim 1, wherein the bonding of the first and second connection pieces to both ends of the resistor element is carried out by welding the resistor element and the first and second connection pieces using a laser.

3. The manufacturing method according to claim 2, wherein the bonding of the first and second connection pieces to both ends of the resistor element is carried out through laser welding under the condition that the upper surfaces of the first and second connection pieces are pressed by pressing members.

4. The manufacturing method according to claim 2, wherein the bonding of the first and second connection pieces to both ends of the resistor element includes heating the rear surfaces of the bonded resistor element and first and second connection pieces, after bonding of the first and second connection pieces to both ends of the resistor element.

5. The manufacturing method according to claim 1, wherein the bonding of the first and second connection pieces to both ends of the resistor element is carried out by welding the resistor element and the first and second connection pieces using an electron beam (E-beam).

6. The manufacturing method according to claim 5, wherein the bonding of the first and second connection pieces to both ends of the resistor element is carried out using the E-beam of 100,000˜150,000 Volt in a vacuum atmosphere of at least 10⁻⁵ torr.

7. The manufacturing method according to claim 1, wherein:
a receiving groove is formed on one surface of each the first and second connection pieces in the bonding of the first and second connection pieces to both ends of the resistor; and
the bonding of the base parts to the upper surfaces of the first and second connection pieces is carried out by applying a conductive bonding member, such as a solder cream, to the receiving grooves.

8. A manufacturing method of shunt resistor assembly comprising:
preparing a resistor element and first and second connection pieces, and bonding the first and second connection pieces to both ends of the resistor element;
pressing measurement terminals, each of which includes a base part and a measurement protrusion, and then bending the measurement protrusions upwardly from the base parts;
bonding the base parts to the upper surfaces of the first and second connection pieces so as to manufacture a shunt resistor;
forming a casing by performing insert injection molding of the shunt resistor; and
combining a substrate, on which a measurement unit is mounted, with the casing.

9. The manufacturing method according to claim 8, wherein:
in the formation of the casing, insert injection molding is carried out so that the measurement protrusions are exposed to the inner space of the casing; and
in the combination of the substrate, on which a measurement unit is mounted, with the casing, connection between the measurement protrusions and the measurement unit is carried out under the condition that the measurement protrusions are inserted into the substrate.
